(19) United States
(12) Patent Application Publication
(10) Pub. No.: US 2016/0201892 A1
(43) Pub. Date: Jul. 14, 2016

(54) Lamp Base with Heat Dissipation Structure and Lamp Thereof, and Illumination Device

(71) Applicant: Hui Chiang CHEN, Taiwan (CN)

(72) Inventor: Hui Chiang CHEN, Pingtung City (TW)

(21) Appl. No.: 14/916,143

(22) PCT Filed: Sep. 2, 2013
(86) PCT No.: PCT/CN2013/082766

§ 371 Date: Mar. 2, 2016

(51) Int. Cl. F21V 29/77; F21V 29/83; F21V 19/00; F21V 29/502; F21V 29/67

(52) U.S. Cl. CPC F21V 29/777; F21V 29/502; F21V 29/673; F21V 19/0055; F21V 29/83; F21Y 2101/02

(57) ABSTRACT

Disclosed are a lamp base with a heat dissipation structure and a lamp thereof, and an illumination device. The lamp base includes a plurality of heat dissipation pieces, fin parts and heat dissipation passage parts, the heat dissipation pieces are mutually combined while the fin parts on the outer wall surfaces thereof and the heat dissipation passage parts on mutually connected connection wall surfaces thereof; and each heat dissipation passage part extends from one end to the other end of the corresponding heat dissipation piece and bends in position close to the other end, and then towards the outer wall surface, so that one end of one heat dissipation piece is in communication with the outer wall surface close to the other end, and the passage size of each heat dissipation passage part is gradually reduced from one end to a bending part of the heat dissipation passage part.

### BACKGROUND OF THE INVENTION

1. Field of the Invention

The present application relates to a lamp, more specifically, relates to a lamp base with heat dissipation structure and a lamp thereof, and an illumination device, which greatly enhances the heat dissipation efficiency of LED.

2. Description of the Related Art

An illumination device nowadays is normally equipped with at least one light emitting module in order to emit at least one light beam to illuminate the surroundings so as to provide illumination effect. Practically speaking, since the LED (Light Emitting Diode) has the effect of high power output and illuminance, low power consumption and long lifespan, manufacture of the aforementioned illumination devices gradually adopts the LED in large quantity.

Since LED generates heat when projecting light beam to the surroundings, failure to dissipate heat generated by the LED efficiently may affect the proper operation of LED, as well as shorten the lifespan of LED and cause lumen depreciation, and even the damage the LED. Henceforth, a heat dissipating module is conventionally disposed in most of the illumination device to enhance the heat dissipation efficiency by taking advantage of the improvement of structural or material characteristics of the heat dissipation module. However illumination device with high illuminance and low power consumption may result in the increment of circuit density and heat sources. So a lamp base with heat dissipation structure solely adopting conventional fin-shaped heat dissipation fins is not sufficient. Consequently there is a more requirement for heat conduction and heat convection.

In light of the aforementioned issues, the inventor of the present application designs a lamp base with heat dissipation structure and a lamp thereof, and an illumination device, after years of research, so as to improve current technical disadvantage, thus improving industrial implementation.

### SUMMARY OF THE INVENTION

The present application aims to provide a lamp base with heat dissipation structure and a lamp thereof, and an illumination device in order to solve the problem pertaining to this art.

In accordance with the objective of the present application, a lamp base with heat dissipation structure is provided, which includes a plurality of heat dissipation pieces, fin parts and heat dissipation passage parts. The heat dissipation pieces are mutually combined to form a body of the lamp base. The fin parts are disposed on outer wall surfaces of the heat dissipation pieces not connected to the adjacent heat dissipation pieces whereas the heat dissipation passage parts are disposed on the connection wall surfaces of the heat dissipation pieces connected to the adjacent heat dissipation pieces. Each of the heat dissipation passage part extends from one end of the corresponding heat dissipation piece to the other end of the heat dissipation piece. Furthermore, the heat dissipation passage part bends at a position close to another end of the heat dissipation piece and the extends towards the outer wall surface of the heat dissipation piece, thus the end of the heat dissipation piece is in communication with to the outer wall surface of the heat dissipation piece close to the other end of the heat dissipation piece. A passage size of the heat dissipation passage part gradually decreases from the one end of the heat dissipation piece to a bending part of the heat dissipation passage part.

Preferably, the heat dissipation passage part further includes a fluid receiving portion and a fluid discharging portion. One end of the fluid receiving portion is located at one end of the heat dissipation piece while another end of the fluid receiving portion is connected to the bending part. One end of the fluid discharging portion is located at the outer wall surface of the heat dissipation piece while the other end of the fluid discharging portion is connected to the bending part.

Preferably, the heat dissipation passage part is in the shape of a concave semicircle.

Preferably, when one of the heat dissipation pieces is joined to another one of the heat dissipation pieces, the heat dissipation passage parts of both the heat dissipation pieces form a circular heat dissipation passage.

Preferably, a connecting part is disposed between the connection wall and the outer wall surface. A plurality of through holes are disposed on the connecting part on one side of the connection wall surface, while a plurality of bolting holes are disposed on the connecting part on the other side of the connection wall to match the through holes, such that the heat dissipation pieces are mutually combined to each other with a plurality of bolting assemblies.

Preferably, the lamp base formed from a plurality of mutually combined heat dissipation pieces is a cylindrical structure. The distance from the center of the lamp base to an edge of the connecting part is larger than the distance from the center of the lamp base to an edge of a fin of each of the fin parts.

In accordance with the objective of the present application, a lamp is further provided. The lamp includes a lamp base, a fan and a light emitting module. The lamp base includes a plurality of heat dissipation pieces, fin parts and heat dissipation passage parts. The heat dissipation pieces are mutually combined to form a body of the lamp base. The fin parts are disposed on an outer wall surfaces of the heat dissipation pieces not connected to the adjacent heat dissipation pieces. The heat dissipation passage parts are disposed on connection wall surfaces of the heat dissipation pieces connected to the adjacent heat dissipation pieces. Each of the heat dissipation passage part extends from one end of the corresponding heat dissipation piece to the other end thereof. Furthermore, the heat dissipation passage part bends at a position close to another end of the heat dissipation piece and then extends towards the outer wall surface of the heat dissipation piece, thus the one end of the heat dissipation piece is in communication with the outer wall surface of the heat dissipation piece close to the other end of the heat dissipation piece. The passage size of the heat dissipation passage part gradually decreases from the one end of the heat dissipation piece to a bending part of the heat dissipation passage part. The fan is disposed at an end of the lamp base far from the bending part. The light emitting module is disposed at another end of the lamp base close to the bending part and possesses at least one light emitting diode.

Preferably, the heat dissipation passage part further includes a fluid receiving portion and a fluid discharging portion. One end of the fluid receiving portion is located at one end of the heat dissipation piece while another end of the fluid receiving portion is connected to the bending part. Meanwhile, one end of the fluid discharging portion is located at the outer wall surface of the heat dissipation piece while the other end of the fluid discharging portion is connected to the bending part.

Preferably, the heat dissipation passage part is in the shape of a concave semicircle.

Preferably, when one of the heat dissipation pieces is joined to another one of the heat dissipation pieces, the heat dissipation passage parts of both the heat dissipation pieces form a circular heat dissipation passage.

Preferably, a connecting part is disposed between the connection wall and the outer wall surface. A plurality of through holes are disposed on the connecting part on one side of the connection wall surface, while a plurality of bolting holes are disposed on the connecting part on the other side of the connection wall to match the through holes, such that the heat dissipation pieces are mutually combined to each other with a plurality of bolting assemblies.

Preferably, the lamp base formed from a plurality of mutually combined heat dissipation pieces is a cylindrical structure. The distance from the center of the lamp base to an edge of the connecting part is larger than the distance from the center of the lamp base to an edge of a fin of each of the fin parts.

Preferably, a fixing portion is disposed on an end of one fin on the fin part to match a fan fixing hole of the fan.

Preferably, a fixing portion is disposed at an end of one fin on the fin parts to match a light emitting module fixing portion of the light emitting module.

Preferably, the length of the lamp base ranges from 60 mm to 160 mm.

Preferably, the length of the lamp base is one of 60 mm, 80 mm, 100 mm and 160 mm.

In accordance with the objectives of the present disclosure, an illumination device inclusive of the aforementioned lamp and a fixing bracket is further provided. The fixing bracket is disposed with a cavity, wherein the cavity is configured to match a shape of the lamp, such that the lamps are arranged in arrays into the cavity.

In a nutshell, the lamp base with heat dissipation structure and the lamp thereof, and the illumination device of the present application come with one or more advantage listed below:

(1) By utilizing the configuration of the heat dissipation passage of the lamp base with heat dissipation structure and a lamp thereof, the heat dissipation efficiency is drastically improved.

(2) By changing the passage size of the fluid receiving portion and the fluid discharging portion of the heat dissipation passage of the lamp base with heat dissipation structure and a lamp thereof, such that the flow rate of the fluid can be increased to enhance the rate at which the cooling air expels the heat.

(3) By utilizing the configuration of the bending part of the lamp base with heat dissipation structure and a lamp thereof, the contact area between the cooling air and the heat can be increased, such that the coolant removes more heat.

### BRIEF DESCRIPTION OF THE DRAWINGS

FIG. 1 is the exploded view of the first embodiment of the lamp according to the present application.

FIG. 2 is the assembly drawing of the first embodiment of the lamp according to the present application.

FIG. 3 is the plan view of the lamp base of the first embodiment of the lamp according to the present application.

FIG. 4 is the schematic diagram showing the flow of gas of the first embodiment of the lamp according to the present application.

FIG. 5 is the exploded view of the second embodiment of the lamp according to the present application.

FIG. 6 is the assembly drawing of the second embodiment of the lamp according to the present application.

FIG. 7 is the schematic diagram of the embodiment of the illumination device according to the present application.

### DETAILED DESCRIPTION OF THE PREFERRED EMBODIMENTS

Reference will now be made in detail to the exemplary embodiments of the present disclosure, examples of which are illustrated in the accompanying drawings. Therefore, it is to be understood that the foregoing is illustrative of exemplary embodiments and is not to be construed as limited to the specific embodiments disclosed, and that modifications to the disclosed exemplary embodiments, as well as other exemplary embodiments, are intended to be included within the scope of the appended claims. These embodiments are provided so that this disclosure will be thorough and complete, and will fully convey the inventive concept to those skilled in the art. The relative proportions and ratios of elements in the drawings may be exaggerated or diminished in size for the sake of clarity and convenience in the drawings, and such arbitrary proportions are only illustrative and not limiting in any way. The same reference numbers are used in the drawings and the description to refer to the same or like parts.

Attached figures will be referred hereinafter in order to illustrate the embodiment according to the lamp base with heat dissipation structure and the lamp thereof, and the illumination device of the present application. For the ease of understanding, like elements in the embodiments below will be designated with like numerals.

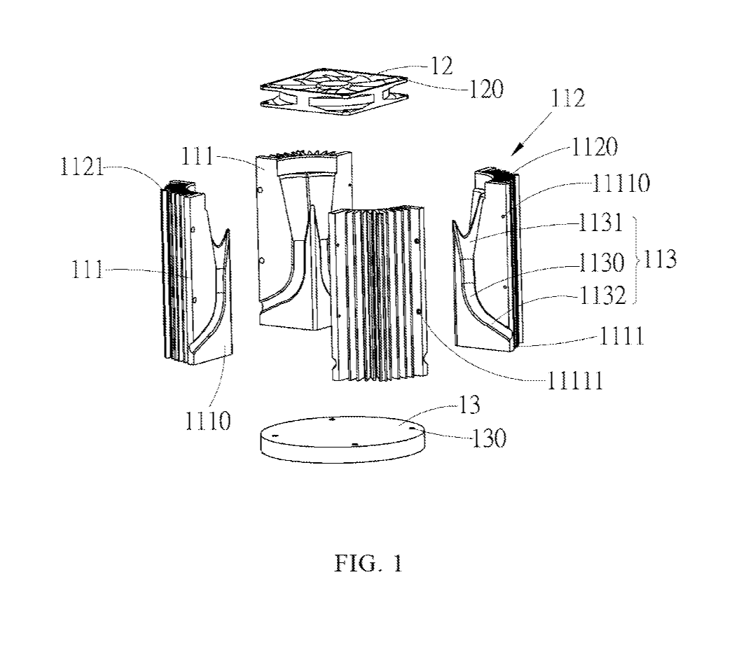

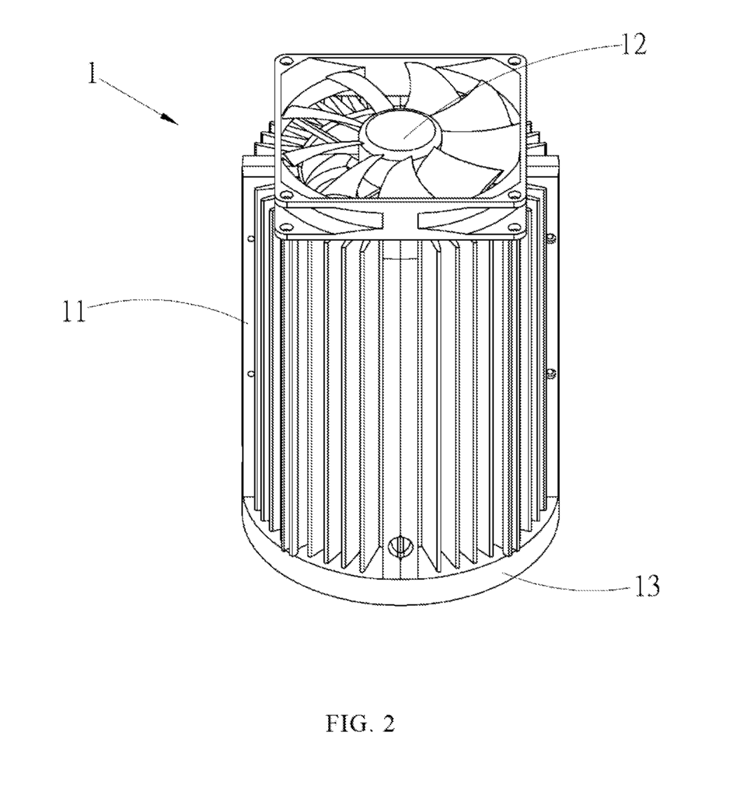

FIGS. 1 to 3 are respectively the exploded view, assembly drawing, and the plan view of the lamp base of the first embodiment of the lamp according to the present application. A lamp 1 includes a lamp base 11 with heat dissipation structure, a fan 12 and a light emitting module 13. The lamp base 11 is disposed between the fan 12 and the light emitting module 13. That is, the fan 12 is fixed on one end of the lamp base 11 while the light emitting module 13 is fixed on the other end thereof, so as to utilize the lamp base 11 to absorb the heat from the light emitting module 13 and at least one LED (not shown in the figure) thereof, and to utilize the fan 12 to ventilate the surrounding air to dissipate heat from light emitting module 13.

The lamp base 11 further includes a plurality of heat dissipation pieces 111, fin parts 112, and heat dissipation passage parts 113. The heat dissipation pieces 111 can be made of the material with superior thermal conductivity such as aluminum, copper and the like, and the material is generally molded into shapes matching each of the heat dissipation pieces 111 through extrusion molding or milling, such that the heat dissipation pieces 111 with mutually matching shapes can be combined to form the body of the lamp base 11. There can be two or more heat dissipation pieces 111, i.e. two, three or four heat dissipation pieces 111, while the present exemplary embodiment utilizes four heat dissipation pieces 111, the quantity of heat dissipation pieces 111 is not limited thereto. The fin parts 112 is disposed on the outer wall surfaces of the heat dissipation pieces 111 not connected to the adjacent heat dissipation pieces 111, and each of the fin parts 112 is composed of a plurality of fins 1120. The heat dissipation passage part 113 is disposed at a connection wall surface 1110 of each of the heat dissipation pieces 111 connected to the adjacent heat dissipation pieces 111. The heat dissipation passage part 113 extends from one end of the corresponding heat dissipation piece 111 to the other end thereof, and bends at a position close to the other end of the heat dissipation pieces 111, and extends towards the outer wall surface of the heat dissipation piece 111, thus the one end of the heat dissipation piece 111 is in communication with the outer wall surface of the heat dissipation piece 111 close to the other end of the heat dissipation piece 111. The passage size of the heat dissipation passage part 113 gradually decreases from the one end of the heat dissipation piece to the bending part 1130 of the heat dissipation passage part 113.

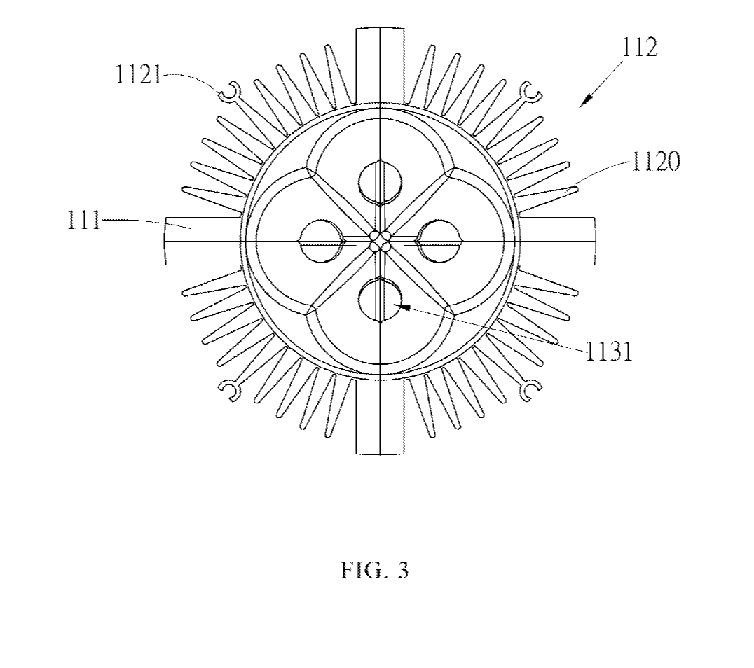

Precisely, the heat dissipation piece 111 can be a quarter-cylindrical structure. As what can be appreciated in FIG. 3, when four heat dissipation pieces are assembled, a cylindrical structure is formed. The fin part 112 is disposed on the perimeter, i.e. the outer wall surface of the quarter-cylindrical structure while the heat dissipation passage part 113 is disposed at the straight wall surface, i.e. the connection wall surface 1110 connected to the quarter-cylindrical structure. A connecting part 1111 is further disposed between the connection wall surface 1110 and the outer wall surface of the heat dissipation piece 1111, that is, both sides of the connection wall surface 1110 are respectively disposed with the connecting part 1111.

Subsequently, the connecting part 1111 on one side of the connection wall surface 1110 is disposed with a plurality of through holes 11110 while the connecting part 1111 on the other side of the connection wall surface 1110 is disposed with a plurality of bolting holes 11111 to match the through holes 11110. When the four heat dissipation pieces 111 are joined together to form the lamp base 11, the combination is reinforced with a plurality of bolting assemblies which pass through the through holes 11110 and then fastened at the bolting holes 1111. In practical implementation, the distance from the center of the lamp base 11 to an edge of the connecting part 1111 can be larger than that from the center of the lamp base 11 to an edge of the fin 1120 of each of the fin parts 112, for easier locking. In simple words, the connecting part 1111 protrudes out from the fin 1120.

The edge of one or two fins 1120 of the fin part 112 are disposed with a C-shaped fixing portion 1121 to match the fan fixing hole 120 of the fan 12. Similarly, a fixing portion 1121 is disposed at an edge of one or two fins 1120 of the fin part 112 to match the light emitting module fixing hole 130 of the light emitting module 13. Preferably, the fixing portion 1121, fan fixing hole 120, and light emitting module fixing hole 130 can be disposed at the mutually matching positions such that only one fixing portion 1121 is needed to fix the fan 12 and the light emitting module 13 altogether. That is, screws and other likewise components can be applied during the assembling process, which pass through fan fixing hole 120 and light emitting module fixing hole 130 and ultimately are fastened at the fixing portion 1121, such that the fan 12 and the light emitting module 13 are respectively fixed at both ends of the lamp base 11.

On the other hand, heat dissipation passage part 113 can be in shape of concave semicircle which dents inwards from the connection wall surface 1110. That is to say, when two or four of the heat dissipation pieces 111 are joined together, the semicircular heat dissipation passage part 113 can form a full circular structure to be a complete heat dissipation passage. Moreover, there can be two heat dissipation passage parts 113 on the connection wall surface 1110, i.e. the heat dissipation passage parts 113 are respectively disposed on each side of the connection wall surface 1110 which form an L shape when connected in right angle. In simple words, when four heat dissipation pieces 111 are joined together, four complete heat dissipation passages are formed therein. Furthermore, the heat dissipation passage part 113 further includes a fluid receiving portion 1131 and a fluid discharging portion 1132. One end of the fluid receiving portion 1131 is situated at the one end of the heat dissipation piece 111 while the other end thereof is connected to the bending part 1130. One end of the fluid discharging portion 1132 is situated at the outer wall surface of the heat dissipation piece 111 while the other end thereof is connected to the bending part 1130. In simple words, the bending part 1130 is connected between the fluid receiving portion 1131 and the fluid discharging portion 1132. The fluid receiving portion 1131 can start from the end surface at one end of the heat dissipation piece 1111, and then incline slightly outwards towards the other end of the heat dissipation piece 111 at a position close to the center thereof, and finally reach the bending part 1130. Whereas the fluid discharging portion 1132 connected to the other end of the bending part 1130 extends in a way that the fluid discharging portion 1132 is inclined towards the other end of the heat dissipation piece 111, and subsequently reach the outer wall surface thereof. Thereby, the contact area between the heat and the flowing air is increased. Note that the passage size of the heat dissipation passage part 113 from one end of the heat dissipation piece 111 to the bending part 1130 of the heat dissipation passage part 113 gradually decreases, i.e. the passage size of the fluid receiving portion 1131 gradually decreases while that of the bending part 1130 and the fluid discharging portion 1132 remain the same. Apparently, the present application is not limited thereto as the passage size of the bending part 1130 and the fluid discharging portion 1132 can be configured to decrease gradually as well.

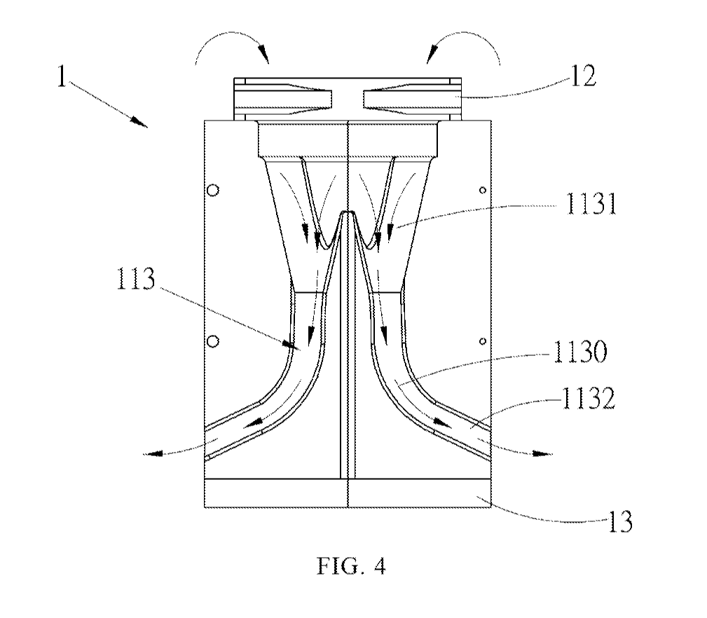

As further illustrated in FIG. 4, the gas flow of the first embodiment of the lamp according to present application is presented, and a semi-circular structure formed from two heat dissipation pieces 111 joined together is presented in the figure for illustrative and descriptive purpose. As can be appreciated in the figure, the fan 12 is disposed at one end of the lamp base 11 away from the bending part 1130. That is, the fan 12 is disposed at the fluid receiving portion 1131. The fan 12 may circulates the air by drawing surrounding air into the fluid receiving portion 1131. The constant intake of the air will push the air in the fluid receiving portion 1131 into the bending part 1130 while the narrowing of passage will cause the speed of airflow to increase, and discharged from the fluid discharging portion 1132 quickly. Generally speaking, the heat dissipation passage mainly utilizes the bending part 1130 and the fluid discharging portion 1132 to dissipate heat, and most of the heat removed by the lamp base 11 from the light emitting module 13 will be concentrated at the bending part 1130. Apart from that, all four fluid receiving portions 1131 on the connection wall surfaces 1110 can be combined to expedite the flow of fluid drawn by the fan 12.

It is noteworthy that the length of the lamp base 11 can range from 60 mm to 160 mm, preferably, can be 60 mm, 80 mm, 100 mm, and 160 mm. The lamp base 11 of the lamp 1 with 80 m, 100 m, and 160 mm in length suits as the outdoor or indoor lamp while that with 60 mm in length suits as the indoor lamp. Here, the outdoor lamp can be street lamp, tunnel lamp, and other outdoor lamp whereas the indoor lamp can be downlight, spotlight, decorative light, hanging lamp, and other indoor lamp. Practically speaking, the lamp base 11 with 160 mm in length can be made in advance, and then the end of the said lamp with the fluid receiving portion 1131 can be cut to meet the actual requirement. In other words, the shorter the required length is, the shorter the length of the fluid receiving portion 1131 is. Intuitively, adjustment can be made to the overall ratio of the heat dissipation passage part 113 in order to meet the required length.

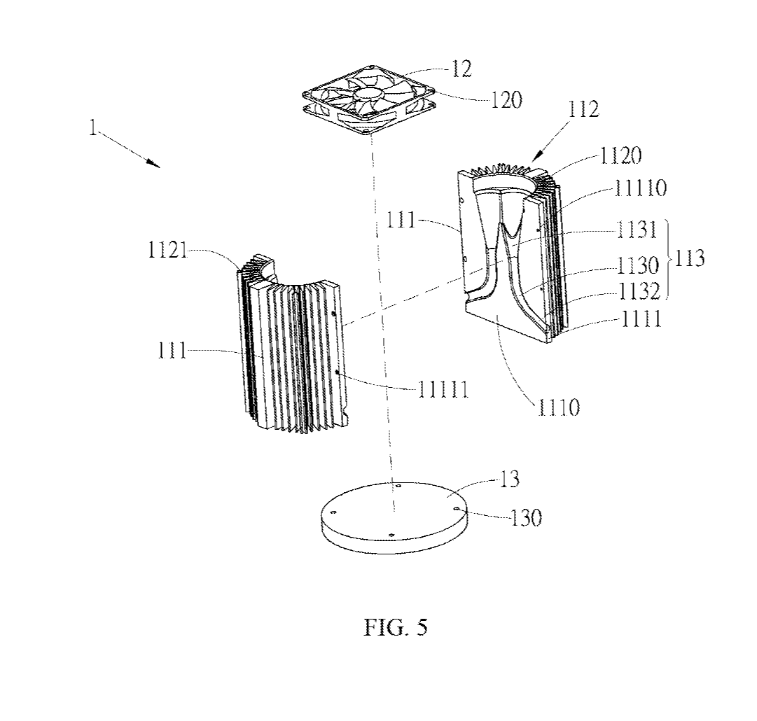

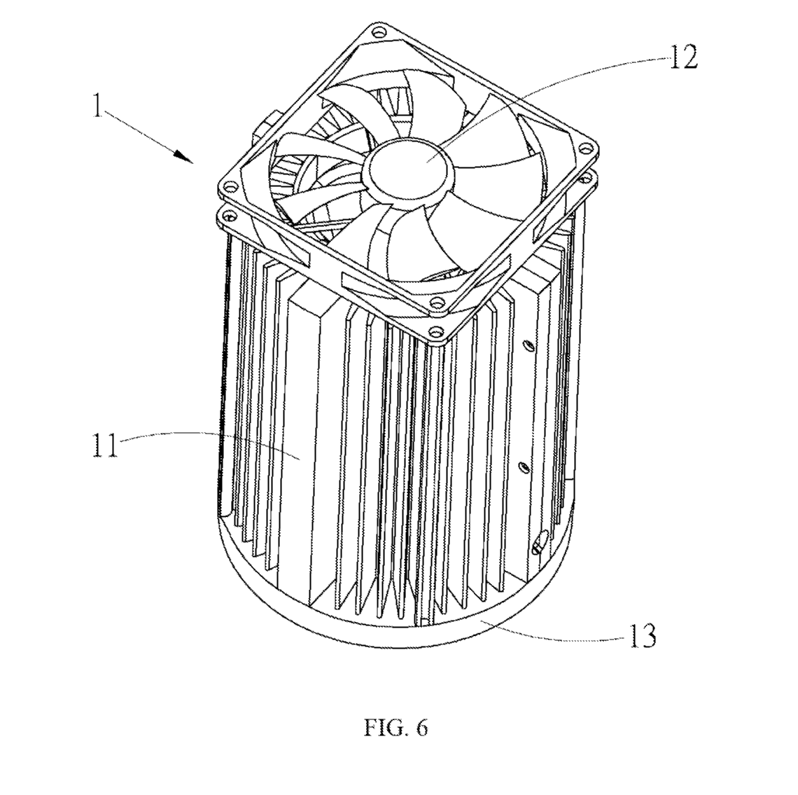

FIGS. 5 and 6 respectively are the exploded view and the assembly drawing of the second embodiment of the lamp according to the present application. In the present embodiment, elements similar to the previous embodiment are connected and operates in similar fashion, thus various narrations are omitted for brevity. The difference between present and previous embodiment is that the former is illustrated with two heat dissipation pieces 111.

Precisely speaking, the lamp base 11 of the lamp 1 of present embodiment is generally formed from two heat dissipation pieces 111 joining together. When viewing the lamp base 11 from above, each heat dissipation piece 111 is a semicircular structure which can be joined to form the cylindrical lamp base 11, as shown in FIG. 6. If there are two heat dissipation passage parts 113, each of the heat dissipation passage parts 113 is disposed on the straight wall surface of the semi-circular structure, which is formed by joining the connection walls 1110 at straight angle, and the heat dissipation passage parts 113 are disposed on the connection wall surface 1110 in a mirrored fashion under this circumstance, and if there is one heat dissipation passage part 113, then the heat dissipation passage part 113 is selectively disposed on the connection wall surface 1110 close to one of the connecting parts 1111. The present embodiment uses two heat dissipation passage parts 113 for demonstrative purpose, i.e. there are two heat dissipation passages when the lamp base 11 is formed by joining two heat dissipation pieces 111. Here, the air drawn by the fan 12 can be discharged from the two fluid discharging portions 1132 toward two different directions, respectively.

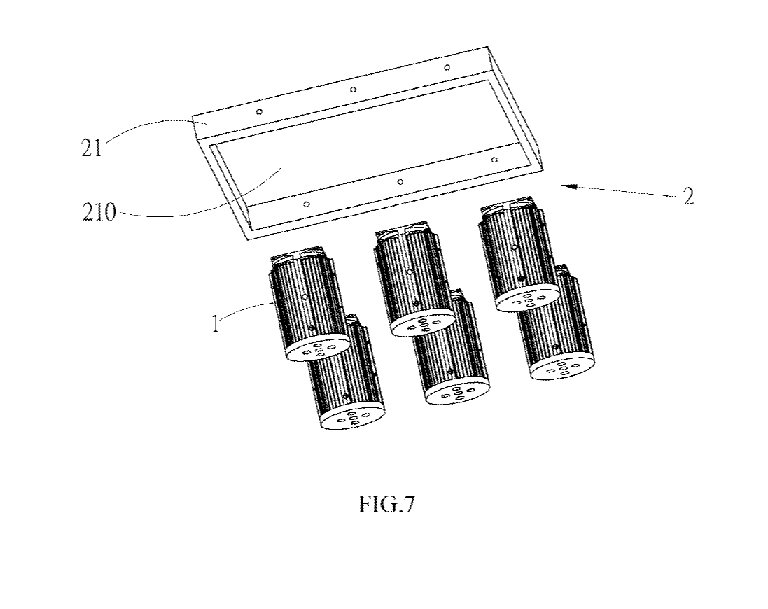

Refer to FIG. 7, which is a schematic diagram of the embodiment of the illumination device according to the present application. In the present embodiment, elements similar to the previous embodiment are connected and operate in similar fashion, so similarities are omitted for brevity. The difference is that a plurality of lamps 1 are disposed in an array to form an illumination device 2 for the purpose of demonstration. The illumination device 2 includes a plurality of lamps 1 from first embodiment or second embodiment and a fixing bracket 21. The fixing bracket 21 has a cavity 210 to reciprocally accommodate the lamps 1, such that lamps 1 can be arranged into the cavity 21. The plurality of lamps 1 can be arranged in circular, rectangular or any other geometrical formation. Although rectangular formation is applied in the present embodiment, the scope of the application is not limited thereto. Besides, the lamps 1 are fixed at the cavity 210 of the fixing bracket 21 with means such as locks, joints or the likes. For example a locking hole (not shown in the figure) can be added to the sidewall of the connecting part 1111, such that a screw or the likes can penetrate the fixing bracket 21 and be fastened at the locking hole, thus holding the lamp 1 in place. The technique involved in holding the lamp 1 in fixing bracket 21 is well known to a person skilled in the art, hence unnecessary details are omitted.

In conclusion, the lamp base with heat dissipation structure and the lamp thereof, and the illumination device of the present application utilize not just the fin to dissipate heat, but the heat dissipation passage and the configuration thereof as well, the latter increases cooling air flow, contact position, and area, which greatly enhance the heat dissipation efficiency.

While the means of specific embodiments in present disclosure has been described by reference drawings, numerous modifications and variations could be made thereto by those skilled in the art without departing from the scope and spirit of the disclosure set forth in the claims. The modifications and variations should in a range limited by the specification of the present disclosure.

1. A lamp base with a heat dissipation structure, comprising:
a plurality of heat dissipation pieces mutually combined to form a body of the lamp base; fin parts disposed on outer wall surfaces of the heat dissipation pieces not connected to the adjacent heat dissipation pieces; and
heat dissipation passage parts disposed on connection wall surfaces of the heat dissipation pieces connected to the adjacent heat dissipation pieces,
wherein each of the heat dissipation passage part extends from one end of the corresponding heat dissipation piece to the other end thereof, and bends at a position close to the other end thereof, and then extends towards the outer wall surface of the heat dissipation piece, thus the one end of the heat dissipation piece is in communication with the outer wall surface of the heat dissipation piece close to the other end of the heat dissipation piece, a passage size of the heat dissipation passage part gradually decreases from the one end of the heat dissipation piece to a bending part of the heat dissipation passage part.

2. The lamp base with heat dissipation structure of claim 1, wherein the heat dissipation passage part further comprises a fluid receiving portion and a fluid discharging portion, one end of the fluid receiving portion is located at one end of the heat dissipation piece while the other end of the fluid receiving portion is connected to the bending part, one end of the fluid discharging portion is located at the outer wall surface of the heat dissipation piece while the other end of the fluid discharging portion is connected to the bending part.

3. The lamp base with heat dissipation structure of claim 1, wherein the heat dissipation passage part is in a shape of a concave semicircle.

4. The lamp base with heat dissipation structure of claim 3, wherein when one of the heat dissipation pieces is joined to another one of the heat dissipation pieces, the heat dissipation passage parts of both the heat dissipation pieces form a circular heat dissipation passage.

5. The lamp base with heat dissipation structure of claim 1, wherein a connecting part is disposed between the connection wall surface and the outer wall surface, and a plurality of through holes are disposed on the connecting part on one side of the connection wall surface, while a plurality of bolting holes are disposed on the connecting part on the other side of the connection wall to match the through holes, such that the heat dissipation pieces are mutually combined to each other with a plurality of bolting assemblies.

6. The lamp base with heat dissipation structure of claim 5, wherein the lamp base formed from the plurality of mutually combined heat dissipation pieces is a cylindrical structure, and a distance from a center of the lamp base to an edge of the connecting part is larger than a distance from the center of the lamp base to an edge of a fin of each of the fin parts.

7. A lamp, comprising:
a lamp base, comprising:
a plurality of heat dissipation pieces mutually combined to form a body of the lamp base;
fin parts disposed on outer wall surfaces of the heat dissipation pieces not connected to the adjacent heat dissipation pieces; and
heat dissipation passage parts disposed on connection wall surfaces of the heat dissipation pieces connected to the adjacent heat dissipation pieces,
wherein each of the heat dissipation passage parts extends from one end of the corresponding heat dissipation piece to the other end thereof, and bends at a position close to the other end thereof, and then extends towards the outer wall surface of the heat dissipation piece, thus the one end of the heat dissipation piece is in communication with the outer wall surface close to the other end of the heat dissipation piece, a passage size of the heat dissipation passage part gradually decreases from the one end of the heat dissipation piece to a bending part of the heat dissipation passage part;
a fan disposed at one end of the lamp base far from the bending part; and
a light emitting module disposed at the other end of the lamp base close to the bending part, wherein the light emitting module has at least one light emitting diode.

8. The lamp of claim 7, wherein the heat dissipation passage part further comprises a fluid receiving portion and a fluid discharging portion, one end of the fluid receiving portion is located at one end of the heat dissipation piece while the other end of the fluid receiving portion is connected to the bending part, one end of the fluid discharging portion is located at the outer wall surface of the heat dissipation piece while the other end of the fluid discharging portion is connected to the bending part.

9. The lamp of claim 7, wherein the heat dissipation passage part is in a shape of a concave semicircle.

10. The lamp of claim 9, wherein when one of the heat dissipation pieces is joined to another one of the heat dissipation pieces, the heat dissipation passage parts of both the heat dissipation pieces form a circular heat dissipation passage.

11. The lamp of claim 7, wherein a connecting part is disposed between the connection wall surface and the outer wall surface, and a plurality of through holes are disposed on the connecting part on one side of the connection wall, while a plurality of bolting holes are disposed on the connecting part on the other side of the connection wall to match the through holes, such that the heat dissipation pieces are mutually combined to each other with a plurality of bolting assemblies.

12. The lamp of claim 11, wherein the lamp base formed from the plurality of mutually combined heat dissipation pieces is a cylindrical structure, and a distance from a center of the lamp base to an edge of the connecting part is larger than a distance from the center of the lamp base to an edge of a fin of each of the fin parts.

13. The lamp of claim 7, wherein a fixing portion is disposed on an end of one fin of each of the fin parts to match a fan fixing hole of the fan.

14. The lamp of claim 7, wherein a fixing portion is disposed at an end of one fin of each of the fin parts to match a light emitting module fixing hole of the light emitting module.

15. The lamp of claim 7, wherein a length of the lamp base ranges from 60 mm to 160 mm.

16. The lamp of claim 15, wherein, the length of the lamp base is one of 60 mm, 80 mm, 100 mm, and 160 mm.

17. A illumination device, comprising:
a plurality of lamps as claimed in claim 7; and
a fixing bracket with a cavity, wherein the cavity is configured to match a shape of the lamps, such that the lamps are arranged in the cavity.
